(19) United States
(12) Patent Application Publication
(10) Pub. No.: US 2012/0293031 A1
(43) Pub. Date: Nov. 22, 2012

(54) COUPLER

(75) Inventors: Andrew Farquhar Atkins, West Sussex (GB); Joshua Jonathan Dalby, East Sussex (GB); Alexander Wooldrige Smith, Northamptonshire (GB)

(73) Assignee: RICARDO UK LIMITED, West Sussex (GB)

(21) Appl. No.: 13/510,519

(22) PCT Filed: Nov. 17, 2010
(86) PCT No.: PCT/GB10/02124

§ 371 Date: Jul. 25, 2012

(30) Foreign Application Priority Data
Nov. 17, 2009 (GB) 0920142.7
Nov. 17, 2009 (GB) 0920143.5

(51) Int. Cl. H02K 49/10; B21B 1/00; B21B 15/00; B23P 17/04

(52) U.S. Cl. 310/104; 29/592; 72/199; 72/206

(57) ABSTRACT

The invention relates to a coupling element for a magnetic gear having a coupling element for coupling magnetic flux between first and second movable members, each having an array of magnetic poles arranged thereon. The coupling element is formed from a sheet of magnetically permeable material and incorporates coupling portions and support portions integrally formed together. The coupling element sheet can be rolled into a cylindrical shape and used as the coupling element in a magnetic gear as described above. Optionally, the magnetic gear is decoupleable by virtue of the coupling element being arranged such that an external magnetic field can be selectably applied to it, thereby causing saturation and resultingly substantially preventing coupling of magnetic flux between the first and second members.

The invention related to a coupler for coupling force between members, and a method for constructing such a coupler.

### BACKGROUND OF THE INVENTION

Existing flywheels for energy storage are sometimes constructed such that the rotating mass of the flywheel rotates inside a chamber containing a vacuum. Operating the rotating mass inside a vacuum is advantageous since it reduces energy losses due to air resistance (also known as windage). However, in order to transfer energy into and out of the rotating flywheel mass, a coupling means is required. Some existing flywheels use a rotating shaft passing through a rotating seal in the vacuum chamber to couple torque from an energy source to the flywheel energy storage means. Rotating seals are never perfect, however, since they inevitably leak and therefore require an environmental management system to be coupled to the vacuum chamber in order to maintain the vacuum despite leakage. Furthermore, the seals become more “leaky” with age and as rotational speed increases, and also wear more quickly at higher speeds. The use of rotating seals is therefore undesirable. The mass, volume and cost of such an environmental management system is undesirable.

Magnetic couplings can be used with flywheels to transfer torque through a vacuum chamber wall, thereby obviating the need for rotating seals. However, the torque transmission capability of such magnetic couplings using permanent magnets has previously been found to be lacking in torque transmission capability.

This has been found to be at least partly because the magnetic flux which passes between the poles of the two rotating members, for a given magnetic pole strength, is limited by the “air gap” between the two members. The air gap in fact, comprises the air gap between the outer rotating member and the vacuum wall, the vacuum wall itself, and a vacuum gap between the vacuum wall and the inner rotating member. Since the vacuum chamber wall must be structurally strong enough to support atmospheric pressure, its thickness is necessarily significant, resulting in a large “air gap” between the inner and outer rotating members.

Existing arrangements have sought to overcome this limited torque coupling capability by employing electromagnetic poles in order to increase the magnetic strength and thereby increase torque coupling capability. However, the use of electromagnetic poles requires an energy conversion, thereby reducing the efficiency of the energy storage flywheel (since the electromagnets require electrical power to operate them, which must be sourced from the energy stored in the flywheel). Furthermore, the additional control and power electronics associated with electromagnetic couplings significantly increases the size, and weight of a flywheel energy storage system incorporating such an electromagnetic coupling, thereby further reducing the energy storage density of such a flywheel energy storage system, both in terms of mass and volume. A method of coupling energy into and out of an energy storage flywheel operating in a vacuum chamber, which is efficient in terms of mass, volume and energy is therefore required.

A further problem with existing flywheels is that while the flywheel itself should be able to rotate at a high angular velocity, the drive shaft which invariably couples the flywheel to an energy source or sink (such as an engine or transmission) and associated components which are outside of the vacuum chamber suffer losses associated with air resistance (or “windage”).

Magnetic gears can generally be used to couple force between movable members (for example drive shafts). Such a magnetic gear is described in UK Patent Application GB 0905344.8. A rotational magnetic gear 100 is shown in FIG. 1a. The device has first and second movable members 110, 120, each having a circumferentially distributed array of alternating magnetic poles 115, 116, 125, 126. Magnetic flux is coupled between the pole arrays by coupling elements 130. The coupling elements 130 minimise the air gap 150, especially when a membrane 140 is present in the air gap. FIG. 1b shows the lines of magnetic flux 160, 170. The membrane 140 allows the two movable members 110, 120 to be operated in different atmospheric conditions, for example, one member may be operated in a vacuum. As one member rotates in a clockwise direction, the other member counter rotates in an anticlockwise direction as the lines of magnetic flux 170 pass from one array of poles to the other array of poles through the coupling elements 130. No physical connection is required therefore the use of rotating seals can be eliminated which is advantageous in that it allows expensive environmental management systems to also be eliminated. The membrane 140 of course needs to be strong enough structurally to withstand the forces exerted by air pressure.

Although not limited to flywheel applications, such an arrangement can be advantageously used to couple a high speed flywheel operating inside a vacuum enclosure to a lower speed drive shaft under atmospheric pressure, since if the number of poles of the first member is dissimilar to the number of poles on the second member a gearing effect results allowing the driveshaft in atmospheric pressure to operate at a lower speed than the flywheel, thereby reducing windage losses. However, in order to achieve a high gearing ratio, the dimensions of the magnetic poles on one of the members must be made as small as possible in order to fit as many as possible in. This, coupled with the need to make the whole assembly as compact as possible dictates that the coupling elements 130 should also be relatively small. Further, in order to maximise the transfer of flux and thereby maximise the torque capacity of the magnetic gear coupling, the device may be extended along its axial length (i.e. generally elongate cylindrical). This leaves the coupling elements 230 with a relatively long length dimension and a relatively narrow cross sectional area. The coupling elements are therefore prone to suffering from a lack of rigidity and can bend, move, or vibrate. This can lead to non-optimal functioning of the device and/or eventual degradation and/or failure. It is also difficult to manufacture such a device since careful alignment is necessary and many production steps are needed to individually assemble the coupling elements into the correct position and hold them there.

Further, the torque transmission capability of a magnetic gear is dependent on the rotational position of the magnetic pole arrays with respect to each other and to the coupling elements, and therefore the torque transmission capability varies as the movable members change position. When torque transfer capability is plotted on a graph against angular position, severe peaks and troughs in the torque curve can be exhibited, as shown in the curve A in FIG. 13. The variable torque transmission capability of such a magnetic gear means that such a gear set must be designed large enough and powerful enough such that its minimum torque coupling capability, as represented by one of the troughs shown at around 20 mm in FIG. 13 is greater than the maximum torque which the gear will be required to handle in use. This variable torque transmission capability is known as “cogging”. Thus, if the magnetic gear could be designed such that the variation in torque transmission capability was reduced such that the torque curve more closely followed a line representing the mean of about 30 N-m as shown in FIG. 13, the magnet arrays could be sized correspondingly smaller, yielding a reduction in cost and size. This would be clearly desirable.

Furthermore, since the angular offset between the input and output shafts of a magnetic gear varies according to the torque applied and to the torque coupling capacity at a given meshing position, if the torque coupling capacity varies with meshing position then this will result in a torsional vibration in the shafts. Such a torsional vibration can reduce the life of the associated mechanical components, and/or can result in failure and/or disengagement. This is an especially serious problem if the rotational speed is such that the frequency of the torsional vibration coincides with a resonance of the mechanical system. Again, it would therefore be advantageous if the variation between the peaks and troughs in the torque curve could be reduced or eliminated. This would allow smaller, cheaper, magnet arrays to be used, since the minimum torque coupling capability would then be much closer to the mean torque coupling capability. Torsional vibration of the shafts would also be reduced, allowing cheaper, lighter and smaller components to be used. A flywheel energy storage system employing such smaller, cheaper and lighter components would have a higher energy storage density.

Additionally, when a magnetic gear coupler such as that previously described is used for coupling a flywheel to an energy source or sink, it is often necessary to decouple the flywheel from the energy source or sink once the flywheel has reached a particular operating speed so as to maintain energy storage in the flywheel without either accepting further energy into the flywheel (which could cause an overload condition) or relinquishing energy from the flywheel before it is needed (which would otherwise represent an energy loss and therefore an inefficiency). A conventional clutch for disengagement/engagement has several disadvantages, including complexity, cost, size, drag (the inability of some designs to completely decouple) and ease of controls. An improved clutch mechanism is therefore required.

### SUMMARY

The invention is set out in the claims.

In accordance with a first aspect of the invention there is provided a magnetic flux coupling element as defined in claim 1 of the appended claims.

In accordance with a second aspect of the invention there is provided a magnetic machine as defined in claim 15 of the appended claims.

In accordance with a third aspect of the invention there is provided a magnetic flux coupling element as defined in claim 21 of the appended claims.

In accordance with a fourth aspect of the invention there is provided a method of manufacturing a magnetic flux coupling element as defined in claim 22 of the appended claims.

In accordance with a fifth aspect of the invention there is provided a magnetic machine as defined in claim 29 of the appended claims.

In accordance with a sixth aspect of the invention there is provided a magnetic flux coupling apparatus as defined in claim 30 of the appended claims.

In accordance with a seventh aspect of the invention there is provided a method of controlling a magnetic flux coupling apparatus as defined in claim 42 of the appended claims.

In accordance with an seventh aspect of the invention there is provided an apparatus, element, machine or method as defined in claim 46 of the appended claims.

### DESCRIPTION OF FIGURES

FIG. 1a is a cross sectional view of a magnetic gear coupling.

FIG. 1b is a close-up cross-sectional view of the magnetic gear coupling of FIG. 1a.

FIG. 1c to 1e show a sequence of rotational alignments of the magnetic gear coupling of FIGS. 1a and 1b.

FIG. 2a is a perspective view of a magnetic gear coupling having a relatively high axial length to diameter ratio.

FIG. 2b is a perspective view of a magnetic gear coupling having “anti-cogging” features.

FIG. 2c is a perspective view of a magnetic gear coupling having alternative “anti-cogging” features.

FIG. 3 is a perspective view of a net of a magnetic gear pole cage.

FIG. 4 is a perspective view of the net of FIG. 3 which has been rolled up and joined into a barrel.

FIG. 5 shows a practical implementation of a magnetic gear pole cage.

FIG. 6 shows a magnetic gear pole cage having staggered coupling segments.

FIG. 7 is a plan view of a net for a magnetic gear pole cage having slanted coupling segments.

FIG. 8 is a plan view of a net for a magnetic gear pole cage having irregular coupling segment lengths.

FIG. 9 is a perspective view of a magnetic gear pole cage having an overmoulded vacuum membrane.

FIG. 10 is a perspective view of a vacuum membrane incorporating coupling elements having saturation means attached.

FIG. 11 is a perspective view of a magnetic gear pole cage having saturation coils attached.

FIG. 12 is a perspective view showing rotatable coupling elements of directional grain magnetic material.

FIG. 13 shows a comparison of two torque coupling capability curves, one for a magnetic gear incorporating anti-cogging, and the other for a conventional magnetic gear.

FIG. 14 is a representative of magnetic field strength versus “air-gap” for magnetic poles coupled by a coupling element.

### DETAILED DESCRIPTION

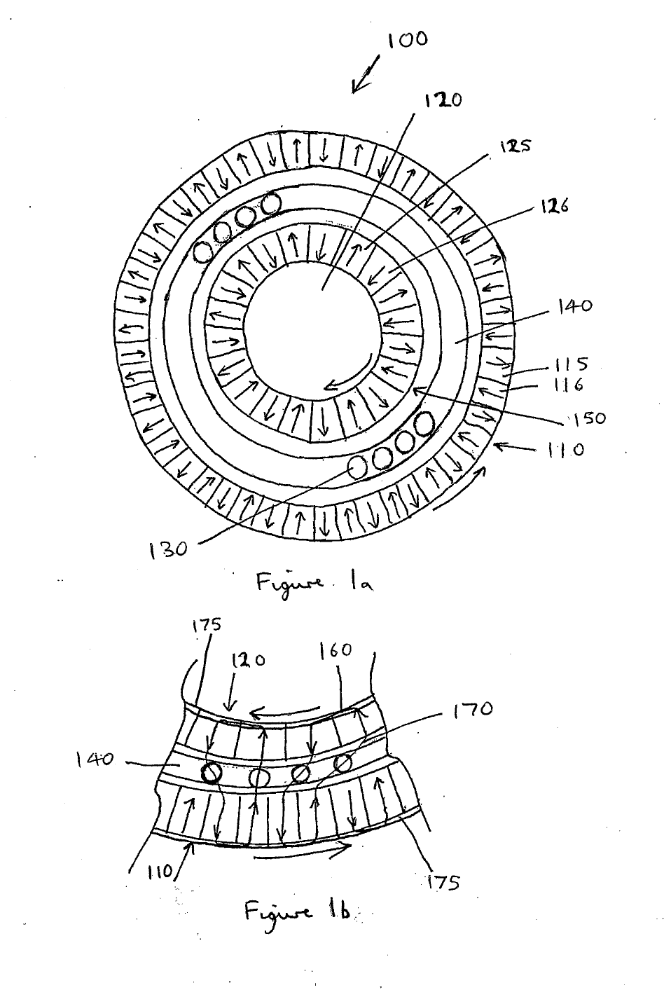

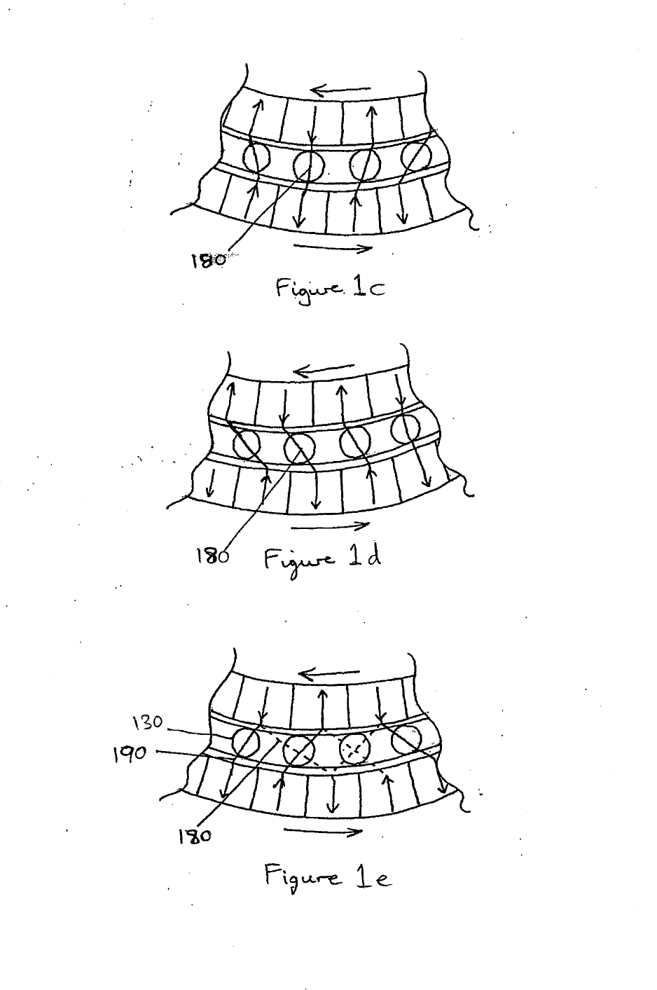

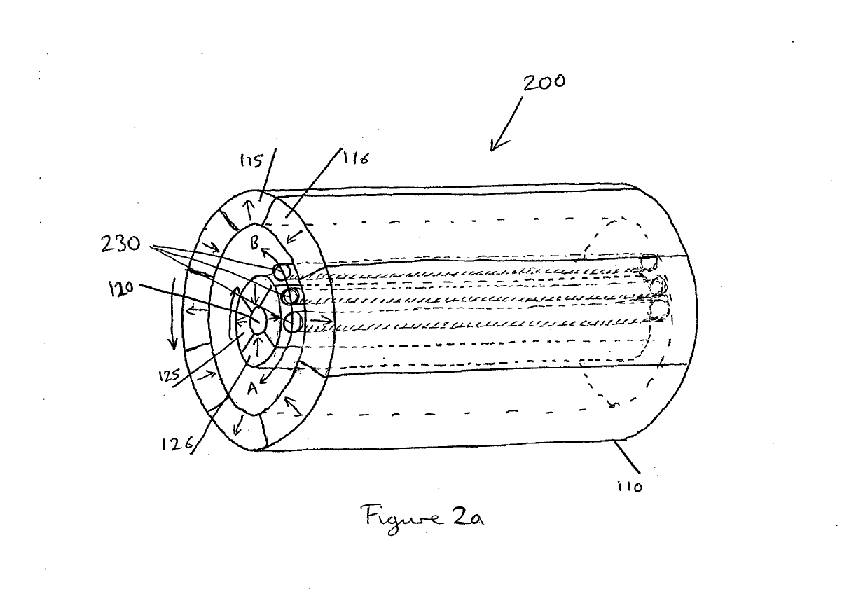

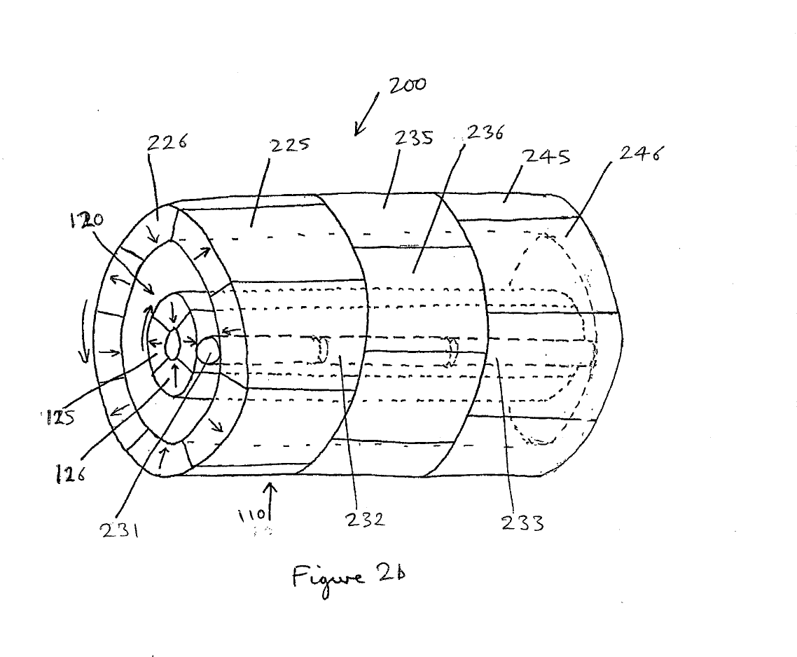

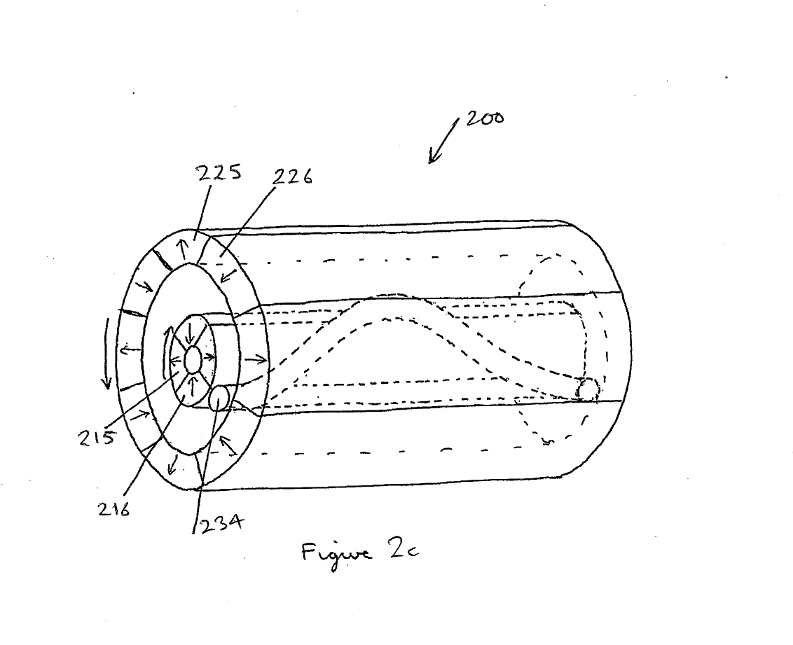

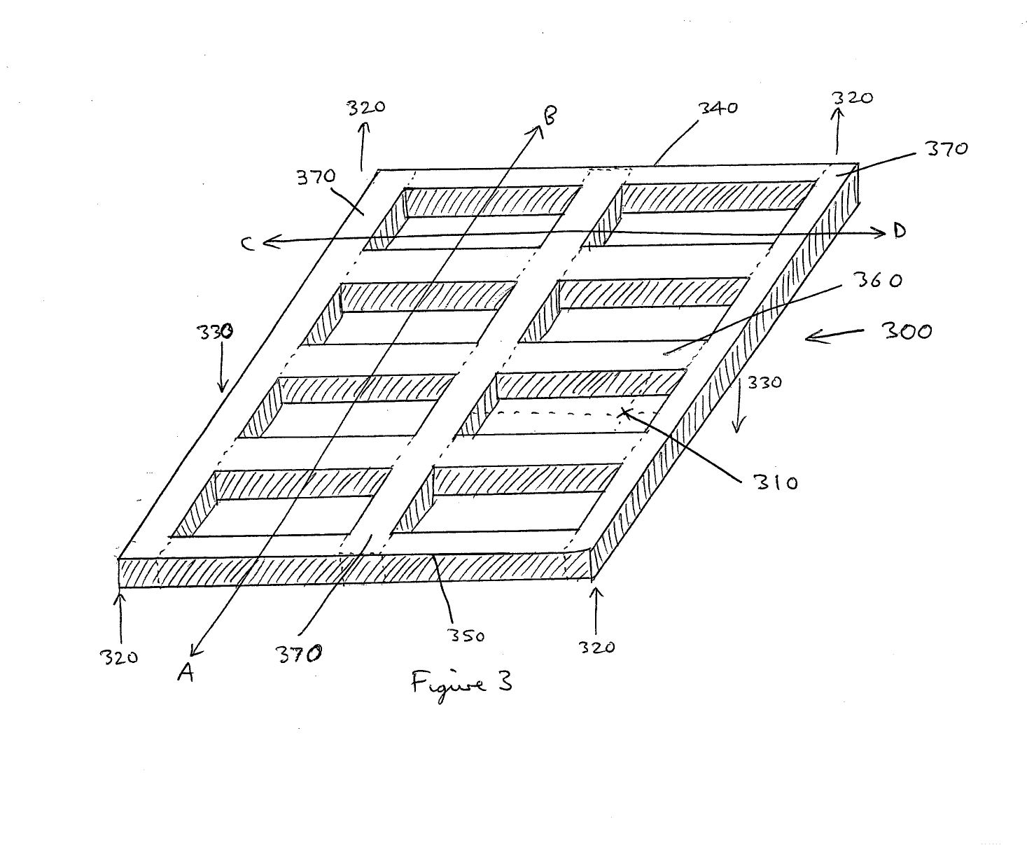

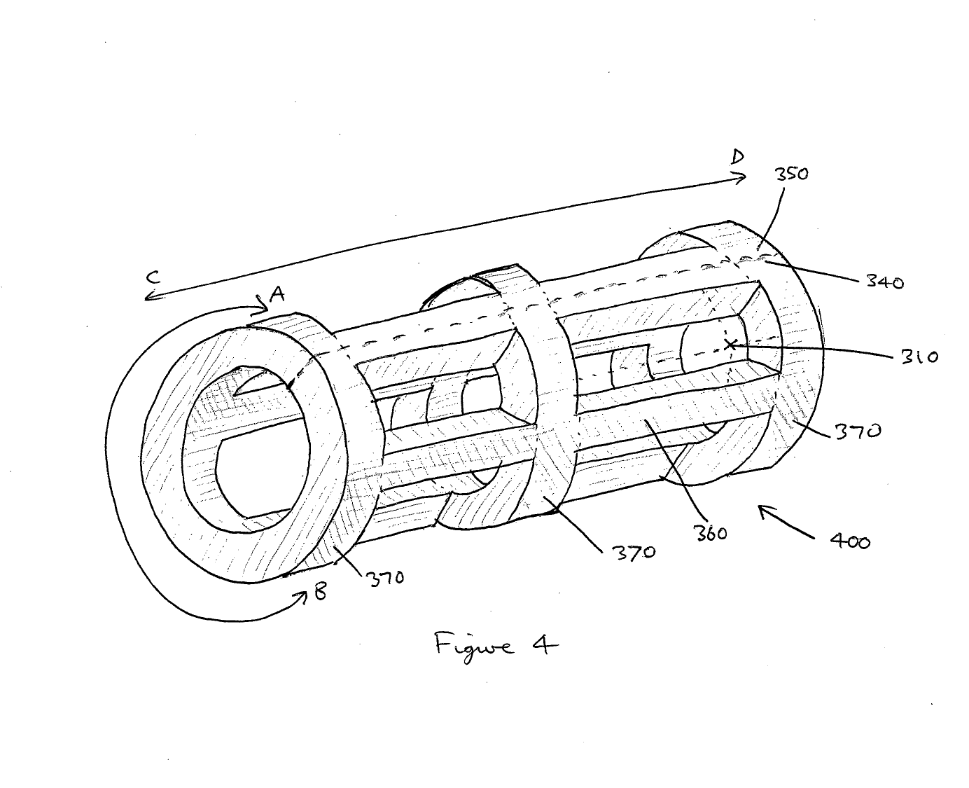

In overview, the invention, in embodiments, provides a magnetic coupling element or series of coupling elements for use in a magnetic gear such as that shown in FIGS. 1a to 2c. In the existing arrangement of FIGS. 1a to 2c, the coupling elements 130, 230 are shown as discrete elements.

Generally, a magnetic gear is constructed and operates as follows. Referring to FIG. 1a, a coupling element 130 is placed between the first and second movable members 110, 120. The magnetic coupling element 130 has a high relative magnetic permeability (in excess of 400) and therefore in operation magnetic flux passes easily through it, from the poles 115, 116 of the first member 120 to the poles 125, 126 of the second member 110 and vice versa. The coupling element is effectively “transparent” to the magnetic field. The coupling element 130 is of a material having a high magnetic permeability, for example soft iron. The coupling element 130 should also have as high as possible electrical resistance, so as to reduce induced eddy currents and the losses due to resistive heating associated therewith. Sufficient coupling members are present, so as to span at least two north-south pole pairs of the member 110, 120 having the widest spaced apart poles 115, 116, 125, 126. The space between coupling elements has a much lower magnetic permeability than the coupling elements, an example material is plastic. When arranged thus, in use, magnetic flux is coupled via each coupling element 130 from the poles of each member 110, 120 and thereby torque is coupled between the first and second members 110, 120. In use, the first and second members 110, 120 contra-rotate.

The magnetic poles 115, 116, 125, 126 are rare earth magnets, since these exhibit high field densities for a given volume of magnetic material. The magnets are smaller lighter, more compact, and able to transmit greater torque. Rare earth magnets have also been found to be good at withstanding compressive forces and are therefore suitable for placing on the inner circumference of a flywheel which rotates at high speed.

Referring still to FIG. 1a, is this cross-sectional view of a concentric arrangement, the first member 120 is concentrically inside the second member 110, and the vacuum housing is concentrically therebetween. Incorporated in the vacuum housing 140 are the coupling elements 130. In this concentric arrangement, the first and second members 110, 120 contra-rotate. A minimum number of coupling elements 130 required is that which will span two pairs of north/south pole pairs of whichever of the first and second members 110, 120 have the greater pole spacing. This minimum number guarantees that torque can be transferred between the members 110, 120 and that the relative directions of rotation of the first and second member is well defined.

The coupling elements 130 can be distributed evenly around its circumference or can be confined to particular regions around the circumference of the vacuum housing 140 only.

The maximum number C of coupling elements 130 required when coupling elements are equally spaced around the circumference of the vacuum housing 140 between the first and second members 110, 120, is equal to the number of north/south pole pairs N of the first member 110 added to the number of north/south pole pairs M of the second member 120. In other words, C=N+M. With C coupling elements 130 evenly spaced around the circumference of the vacuum housing 140, the correct spacing between coupling elements 130 results.

In the case where the coupling elements 130 are confined to particular regions of the circumference (i.e. in embodiments having coupling elements at only some of the locations around the circumference at which coupling elements 130 would be placed if the full number (C=N+M) of coupling elements were included), the coupling elements 130 are spaced with respect to each other as if the full number of coupling elements 130 were equally spaced around the vacuum chamber 140 wall, except that some elements 130 are omitted. When some of the coupling elements 130 are omitted, as above, the positioning of the remaining coupling elements 130 is ideally chosen such that coupling elements 130 are positioned symmetrically around the vacuum chamber 140 wall circumference, so as to avoid net forces resulting.

Backing iron 175 is arranged on the side of the poles 115, 116, 125, 126 facing away from the coupling elements 130 so as to aid the transmission of magnetic flux between the mutual pole pairs of each one of the first and second members 110, 120. Further, the backing iron aids the longevity of the permanent magnets.

Such a concentric magnetic geared coupling can be constructed using standard machining techniques.

The first and second members 110, 120 can have the same number of north/south pole pairs, or can have a different number of north/south pairs. In the shown embodiment, the second member 110 has a lower number of north/south pole pairs than the first member 120. In operation, when the first member 120, having a number of north/south pole pairs m, is rotated in a anticlockwise direction, the second member 110, having a number of north/south pole pairs n, rotates in a clockwise direction. The second member 110 rotates at a speed relative to the rotational speed of the first member 120 multiplied by a factor: n divided by m. FIG. 1b shows the lines of magnetic flux 170 which pass between the poles of the first and second members 110, 120, via the coupling elements 130 which are embedded in the vacuum chamber 140 wall.

FIGS. 1c to 1e show a sequence of a rotation of the first and second members 110, 120 through three positions. FIG. 1c shows the lines of flux between the poles of the first and second members 110, 120 in a first position. FIG. 1d shows the top member having rotated slightly in a clockwise direction, and the bottom member having rotated slightly in an anti clockwise direction. The lines of flux 170 have accordingly moved position, and in particular a line of flux 180 has stretched. FIG. 1e shows a further rotation of the top member in a clockwise direction and of the lower member in an anti clockwise direction. The line of flux 180 has now stretched so far that an alternate linkage via the left most coupling element 130 has become preferable. The flux path thus switches to the new left path 190. The torque transferred from the first member to the second member is equal to the rate of change of flux as the lines of flux switch from one route to another route in this way.

A further advantage from the use of rare earth magnets results from their high flux density per unit size, particularly when used in this way, since it is possible to arrange a large number of pole pairs around the circumference of the first and/or second members and thereby increase the rate of change of flux and thereby increase the torque coupling capability.

Also, due to the relatively small size of rare earth magnets for a given strength, it is possible to have a large ratio between the number of pole pairs on the first member and the number of pole pairs on the second member, since many magnets can be packed into a small size thereby delivering a high gear ratio in a compact size. This has the advantage particularly in flywheel applications employing a vacuum chamber in that the driveshaft and associated components which run in air are able to be run at a lower speed, thereby reducing losses associated with windage and air resistance, while the flywheel inside the vacuum chamber is geared by the magnetic coupling to run at a higher speed, so as to increase the energy storage density of the flywheel.

Existing flywheel energy storage systems employ a gear box to allow the flywheel inside the vacuum chamber to rotate at a high speed while the drive shaft to the energy source/sync is able to rotate in air at a slower angular velocity. However, gear boxes suffer frictional losses and increase the cost, complexity and size of the energy storage system. Magnetic gears suffer from these problems to a lesser extent.

Furthermore, the coupling elements 130 reduce the air gap between the magnetic poles and enable permanent magnets to be used to couple a high level of torque between the first and second elements, avoiding the need for an energy conversion, as would be required for example if electromagnets were used. By using the coupling elements 130 electromagnets are not required since the more efficient arrangement allows the more limited field strength of permanent magnets to be sufficient.

According to the approach described, the use of rotating seals is completely eliminated, thereby eliminating the need for environmental management apparatus to maintain the vacuum inside the vacuum chamber 140. The vacuum inside the vacuum chamber can remain there indefinitely since the chamber is completely sealed, using no rotating seals which can leak. The removal of the associated environmental management equipment (for example a vacuum pump, lubrication pump, associated pipe work and systems, control systems/electronics) further reduces the flywheel storage system weight and size and increases the energy storage density. Furthermore, reliability of this simpler system is accordingly improved and cost is reduced. Thereby a highly efficient flywheel energy storage device is provided.

The removal of rotating seals also allows the flywheel to rotate at a faster speed than would otherwise be possible due to degradation rates of the seals (which become worse as rotation speed increases), further increasing the energy storage density. Parasitic losses due to shear in the seal lubrication fluid (which is a necessary feature of rotating seals) will also be reduced by removal of the seals.

Of course, it will be appreciated that while FIGS. 1a to 2c and their accompanying description generally show and describe embodiments having magnetic field generating elements (also referred to as poles) comprising permanent magnets which (in use) generate a moving magnetic field pattern by virtue of the magnetic field pattern being fixed relative to each member and by rotation of the member, in other embodiments the permanent magnet pole arrays of the first and/or second member could each be substituted with other elements such as an array of electromagnetic poles. Each electromagnetic pole array could be energised in a predetermined manner so as to produce an electromagnetic field pattern substantially the same as that produced by an array of permanent magnet poles. Alternatively, the member could be fixed relative to the coupling element and the electromagnetic poles be energised in a sequence so as to produce an alternating magnetic field pattern which is movable by virtue of the sequencing of the electromagnetic poles, relative to the coupling element. In still other embodiments the moving magnetic field could be produced by a combination of moving the member and sequencing the energisation of the electromagnetic poles.

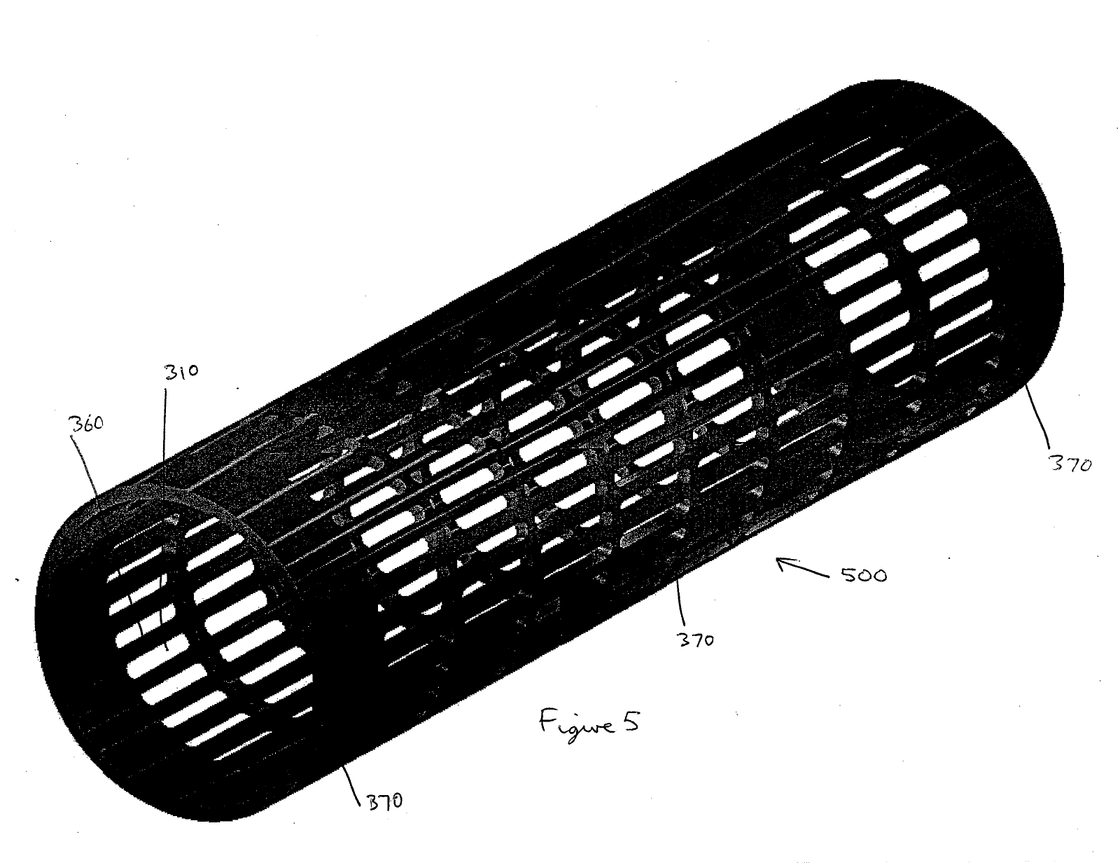

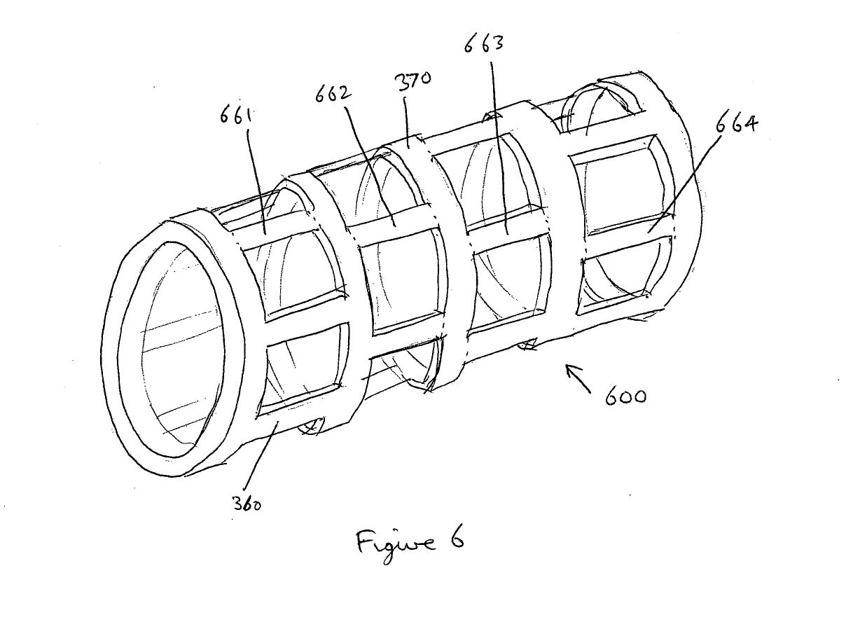

Referring to FIG. 3, in a first embodiment of the invention, a sheet of material 300, shown in a rolled out/flat net configuration for ease of understanding, comprises holes 310 between coupling element portions 360 and support members or portions 370. In this embodiment, the coupling elements are comprised of a sheet of material having holes thereby to create a lattice structure which is rolled into a cylinder or barrel as shown in FIGS. 3, 4 and 5. Referring also to FIG. 4, it can be seen that the structure shown in FIG. 3 is, during manufacture, formed into a barrel having an axis, (represented by the line CD), and a circumference (shown in FIG. 4 as line AB). It can be seen that the features of FIG. 3 correspond to those of FIG. 4 and that the net (or web) 300 of FIG. 3 is arranged such that in manufacture, it can be rolled up to form the barrel (or cylinder) shown in FIG. 4. Of course the barrel can be formed in any other appropriate manner.

The support members 370 of FIG. 3 correspond to the circumferential support members 370 in FIG. 4. The coupling elements 360 which are aligned substantially in the axial direction CD in this embodiment correspond to the coupling elements 360 in FIG. 4. The coupling elements 360 are regularly spaced along the line AB in FIG. 3, such that when the net 300 is rolled into a barrel as shown in FIG. 4, the coupling elements 360 are aligned parallel to the axis of the barrel 400 and extend circumferentially spaced around the barrel.

The ends 340, 350 of the net 300 are arranged to be joined either by welding, by using adhesive, or by other known fixing methods. One or more support members are incorporated. In some embodiments, only one support member 370 is required, but in other embodiments more than one support member may be incorporated. Each support member 370 shown in FIG. 3 has a straight portion, such that when the net 300 is rolled into a barrel 400, each support member forms a hoop, adjacent hoops being joined by the axially aligned coupling elements 360. The support members 370 thereby provide hoop strength to the barrel and locate the coupling elements in position. It can be seen that in a manufacturing operation by, for example, applying upward pressure at end points 320 of the support in FIG. 3, and downward pressure at centre points 330 in FIG. 3, the net 300 would be deformed into an approximately U section, which could form a first step of a process which transforms the net 300 into a barrel 400.

The axial length of the coupling elements 360 between each support element 370 (in the direction CD) is preferably large relative to the spacing between the coupling elements 360 (which corresponds to the dimension of the holes 310 in the direction AB, hence the holes are rectangular and elongated in the axial direction). This is so as to ensure that the coupling elements 360 correspond generally to the discrete coupling elements 230 in the existing magnetic gear of FIG. 2a, thereby performing their function of providing discrete regions which are permeable to magnetic flux, interspersed by regions which are less permeable to magnetic flux.

However, the length of the coupling element 360 in the axial direction CD, between each support member 370, also affects the tendency of the coupling element 360 to bend under forces exerted on it in operation, and the tendency of the coupling element to resonate at certain gear operating speeds. The length of the unsupported coupling element 360 between each support element 370 can be selected so as to trade off the requirements for mechanically supporting the coupling elements 360 and the requirement that there should be holes 310 between coupling elements 360 in order to provide alternating regions of high and low permeability. Of course the relative width of the coupling element portions and support element can also be varied to meet this requirement.

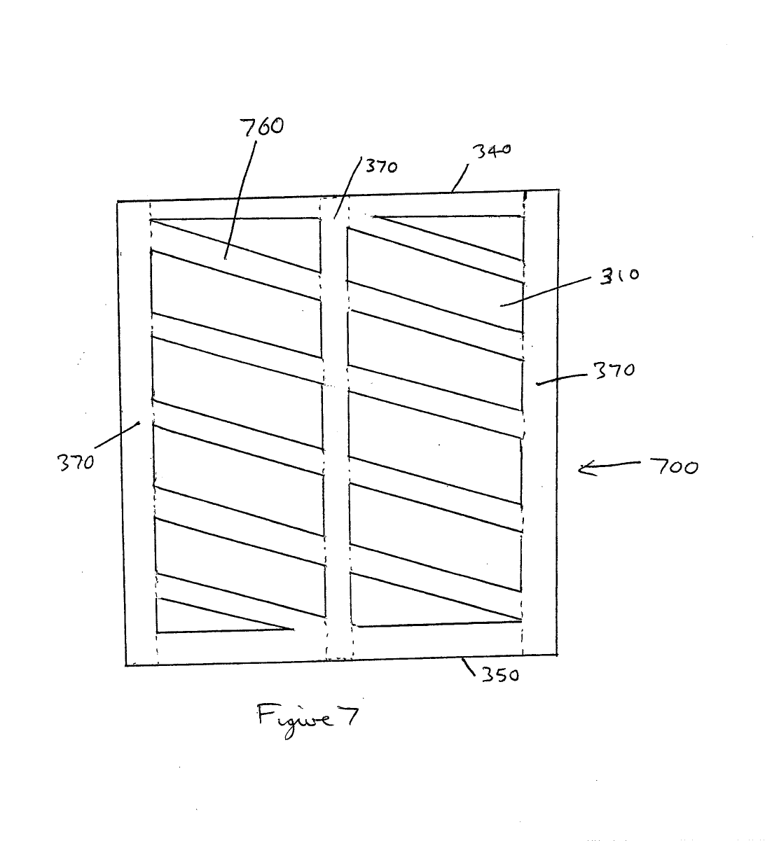

A practical embodiment of the barrel or “pole cage” 400 shown in FIG. 4 is shown in FIG. 5 at 500. FIG. 5 shows a pole cage 500 incorporating support elements 370 at each end which are wider than the support elements 370 between the ends. It can be useful to provide wider support members at the ends in order to provide additional mechanical rigidity and/or to provide a surface for mounting other components on. The pole cage 500 shown in FIG. 5 also has rounded ends to the holes 310. This feature reduces stress at the extremities of the holes and thereby improves the strength and reliability of the pole cage 500. The pole cage 500 can be constructed of steel or other materials which are similarly highly permeable to magnetic flux. Preferably, the pole cage construction has low electrical conductivity, especially in the circumferential direction. To achieve this, a laminated form of construction can be employed, having multiple alternating layers of permeable (and possibly also electrically conductive) material and non-conductive material. The materials used and the thickness of the laminations can be chosen to provide properties of high magnetic permeability and low electrical conductivity.

As previously shown in FIGS. 3 and 4, the pole cage 500 is formed initially from a flat sheet. The holes 310 are then punched, cut, drilled, eroded or otherwise formed by well known processes, for example laser cutting or stamping. The flat sheet is then formed into a barrel and joined along its ends 340, 350, for example by welding or by gluing. Welding provides a strong join with good electrical continuity, however in some embodiments gluing may be preferred for manufacturing efficiency. It may also be preferred in some embodiments for there not to be good electrical continuity round the circumference of the pole cage 500, as having an electrical break in the circumference of the pole cage 500 can increase efficiency in use because it prevents eddy currents from circulating around the pole cage 500.

Yet further the pole cage can be formed in any other appropriate manner including moulding, sintering, shaping, extruding or otherwise.

The pole cage 500 of this first embodiment would be used in a magnetic gear 100, 200 such as that shown in FIGS. 1a to 2c, replacing the conventional coupling elements 130, 230, and being situated concentrically between the first and second members 110, 120.

The circumferential support members 370 support the coupling elements 360, thereby preventing bending, deflection and resonance to at least some extent, whilst allowing a magnetic gear using such a pole cage 500 to operate satisfactorily. The coupling elements for a magnetic gear as described in this embodiment have the advantage of reducing the cost of constructing an array of coupling elements, and therefore the cost of any magnetic gear using such coupling elements is reduced. This is since all the coupling elements can be formed in fewer steps, and without complicated pre-stressing of the coupling element (which would also require additional mechanical support in order to counteract the pre-stress forces). Further advantages arise from other optional features which will be described below.

According to another aspect, as previously discussed, and referring again to FIG. 1a, magnetic gears can exhibit a variable torque coupling capability with rotational meshing position of the first and second members 110, 120. This has been found to be a result of magnetic flux (as shown in FIGS. 1c-1e) switching from a first path 180 to a second path 190 as the first and second members 110, 120 move past each other. A further cause of variation in the torque coupling capability of a magnetic gear coupling is due to the varying magnetic flux path lengths (shown in the sequence of FIGS. 1c to 1e) as the first and second members 110, 120 move past each other. A longer magnetic flux path experiences greater magnetic reluctance, thereby reducing magnetic flux density and, as the torque is proportional to the rate of change of flux, reducing the torque coupling capability of the magnetic gear at that angular meshing position.

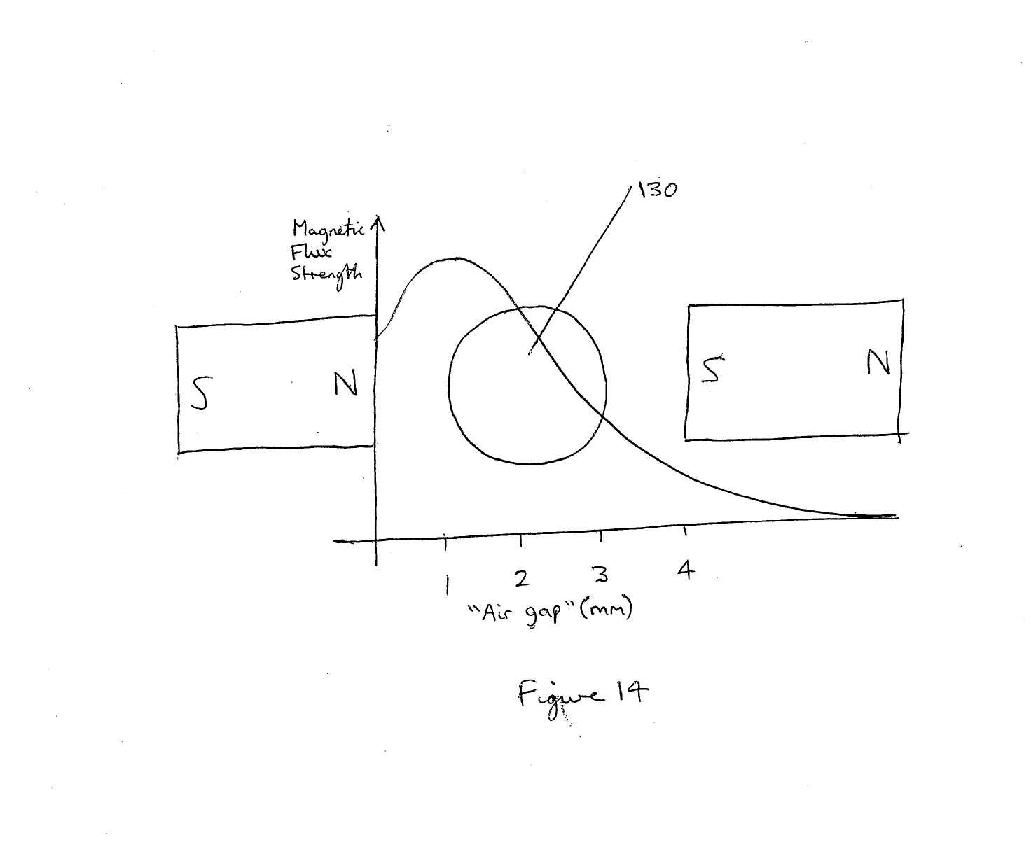

Following now to FIG. 13, the variation of torque coupling capability for a particular physical implementation with respect to the angle of an input shaft can be seen as the curve A which exhibits large exclusions of torque coupling capability (between approximately 20 Nm and 50 Nm).

It has been found that variation of torque coupling capability with meshing angle (or “cogging”) can be reduced by splitting each magnetic pole of a member, into “split parts” (225, 226, 235, 236, 245, 246), as shown in FIG. 2b. The split parts are arranged in the direction of motion so as to form split arrays. The split arrays are arranged side by side along an axis orthogonal to the direction of motion, as shown in FIG. 2b. Each split array is offset in the direction of motion with respect to another split array, such that a spread of relative positions is covered. The spread of positions should cover approximately at least the distance of a north-south pole pair of the member 110, 120 having the widest pole spacing. Since the relative positions of the split arrays are spread (or “staggered”) over a range of positions, it is not possible for a pole 225, 226, 235, 236, 245, 246 of each of the split arrays to each simultaneously align completely with a coupling element 130, 231, 232, 233 and with a pole 125, 126 of the other member 120, thus “complete alignment” is prevented. Thereby, by splitting and staggering poles of one or both members 110, 120, and/or by splitting the coupling element 231, 232, 233 and staggering the positions of each split coupling element part 231, 232, 233, complete alignment of the poles of the members 110, 120 and/or the coupling elements 130 is prevented.

The result of the arrangement shown in FIG. 2b, which prevents complete alignment, is that, referring back to FIGS. 1c-1e, the position (an angular position in this embodiment) at which flux lines switch from one coupling element to another coupling element, or from one split pole to another split pole, varies between each split array. If, as in the embodiment shown in FIG. 2b, there are three split arrays, and those split arrays are offset in the direction of motion so as to prevent complete alignment of the poles and coupling elements (rotationally offset in this embodiment), then for a small movement (that would otherwise have caused a transition in the whole field if complete alignment was allowed) there will now be only one fraction of the flux shown switching (one quarter in this embodiment). However, in this embodiment there will be three times as many such transitions for a particular movement distance of the assembly (e.g. a full rotation). The torque transfer for that movement is thus in total the same, but is delivered more continuously leading to lower “cogging”. For clarity, only a single coupling member is shown in FIG. 2b. As shown in the Figure, this coupling member can also be split into coupling parts. Splitting the coupling member in this way reduces the interaction between the split arrays of the members, but is not necessary for a reduction in “cogging” to be achieved.

It will also be appreciated from FIG. 2b that, instead of, or in addition to the splitting of first and/or second pole arrays (into split arrays) along their axial length (the axis is orthogonal to the direction of relative motion), and the offsetting in the direction of motion of each split array, each coupling element 130 can optionally, alternatively or also, be split into coupling parts along its axial length 231, 232, 233 as shown, and these coupling parts can accordingly also be offset. One, or a combination of these features can be incorporated so as to diversify the positions at which magnetic flux switches from one path to another path as shown in FIG. 1e. This strategy may be referred to as staggering the poles, or staggering the coupling elements. Staggering the poles and/or coupling elements results in a reduction of the variation of torque coupling capability when plotted against position. This is shown in FIG. 13 as the curve B which exhibits a relatively small variation of torque coupling capability, (around 25 to 35 Nm). This represents an improvement in performance over conventional magnetic gear couplings, for the following reasons.

The minimum torque coupling capability of the improved magnetic gear is greater and does not fall below 25 Nm, shown in FIG. 13. (In contrast, the prior art magnetic gear torque coupling capability falls at some angular meshing positions to a figure of less than 20 Nm). Accordingly, for a given design torque capability, the size of the magnets used in the improved magnetic gear can accordingly be reduced in size while still delivering the torque coupling capability. The reduction in variation of torque coupling capability thereby allows such an improved magnetic gear to be designed with smaller, lighter and cheaper magnets.

A further advantage of the improved magnetic gear described herein is that since the torque coupling capability has less variation, in use, when a torque is applied to the improved magnetic gear coupling, the resultant angular offset or “slippage” (being proportional to the torque applied and the torque coupling capability), is more constant than that which would result in a prior art magnetic gear coupling. Thereby, torsional vibrations caused by this variation are reduced. The reduced torsional vibrations are less likely to cause severe resonance which might damage components, require component strength to be uprated with associated cost implications, or cause the coupling to slip out of mesh and lose alignment.

A further alternative is shown in FIG. 2c whereby the coupling element 234 follows a sinusoidal path along an axis orthogonal to the direction of movement of the first and second members (in this embodiment, along the axis of rotation of first and second members) such that its position in the direction of motion of the first and second members varies along the axis. The shape of the coupling element is symmetrical between its ends, along the axis so as to balance the axial forces resulting and thereby cancel them. Thereby, the position at which magnetic lines of flux switch position, as shown in FIG. 1e, varies with axial position. Again, only a single coupling element 234 is shown in figure for clarity. However, multiple coupling elements will normally be employed as described earlier.

Furthermore, although the Figures generally show rotating examples, with the first and second members either alongside each other or concentric with each other, an end-on alignment of first and second members is also possible. In such an end-on arrangement, the coupling element can either be curved, or can be split into parts which are staggered, and the coupling element and/or the poles of the first and second members can also be split, this time rather than being split along the axis of rotation, they are split in a radial direction.

Furthermore one or both of the first and second members could be unrolled so as to form a planar surface. Such an arrangement would resemble a rack and pinion, or a pair of tracks slidable over each other, with the coupling element being disposed therebetween. In such arrangements, the first and/or second members and/or the coupling elements would be staggered in a direction which is orthogonal to the direction of movement and parallel to a surface between the members.

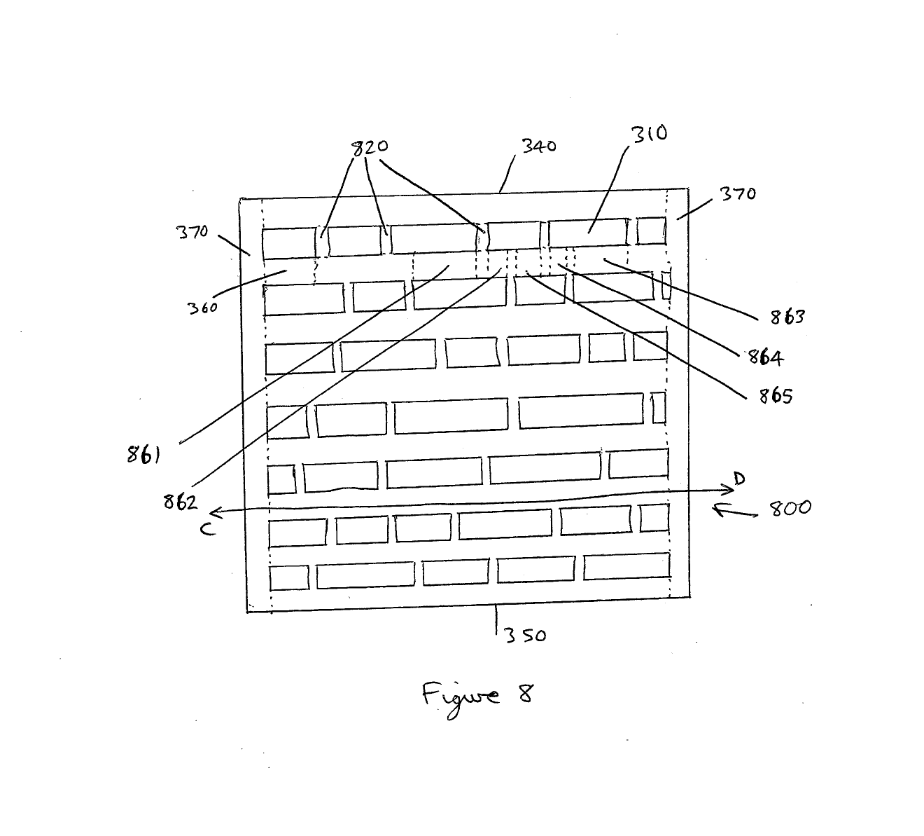

According to the further aspect with reference to FIG. 6, a further embodiment of the invention is shown in which a “pole cage” configuration is arranged to address problems associated with “cogging” (variation in torque coupling capability versus relative alignment of the first and second members 110, 120). Coupling element portions 661, 662, 663, 664 (which are divided from each other along the axial length of the pole cage 600 by the circumferential support members 370) are also radially offset (i.e. not axially aligned) around the circumference of the pole cage 600. This would correspond to each of the coupling elements in FIG. 3 (which lay substantially in a line in the direction CD) being offset from the other coupling elements 360 in the direction AB, in a staggered configuration.

The staggered coupling elements 661, 662, 663, 664 as shown in FIG. 6, if used in a magnetic gear such as that shown in FIG. 2a, with the pole cage 600 located concentrically between the inner member 120 and an outer member 110, would prevent complete alignment of the magnetic poles 115, 116, 125, 126 of the first and second members 110, 120 and the coupling elements 661, 662, 663, 664. As discussed above this has the effect of reducing the variation in torque coupling capability of the magnetic gear versus the relative rotational position of the components of such a magnetic gear.

Thus, referring to FIG. 13, such a magnetic gear would exhibit a torque coupling capability versus rotational position more similar to the curve B shown in FIG. 13 which varies between approximately 26 N-m and 35 N-m. This torque curve varies less with rotational position than a torque curve A such as that shown in FIG. 13 which varies between approximately 18 N-m and 51 N-m, which is the curve produced for comparison by a conventional magnetic gear. The minimum torque coupling capability (shown as the troughs in the curves of FIG. 13) is greater in the curve which has less variation. That is to say, a magnetic gear having staggered coupling elements 661, 662, 663, 664 exhibits less variation in torque coupling capability versus rotational position, and therefore has a higher minimum torque coupling capability, this being closer to the mean torque coupling capability. Thus, for a given design requirement of a minimum torque coupling capability, if the staggered coupling elements 661 to 664 of FIG. 6 are employed, a smaller, cheaper and more compact magnetic gear can be produced.

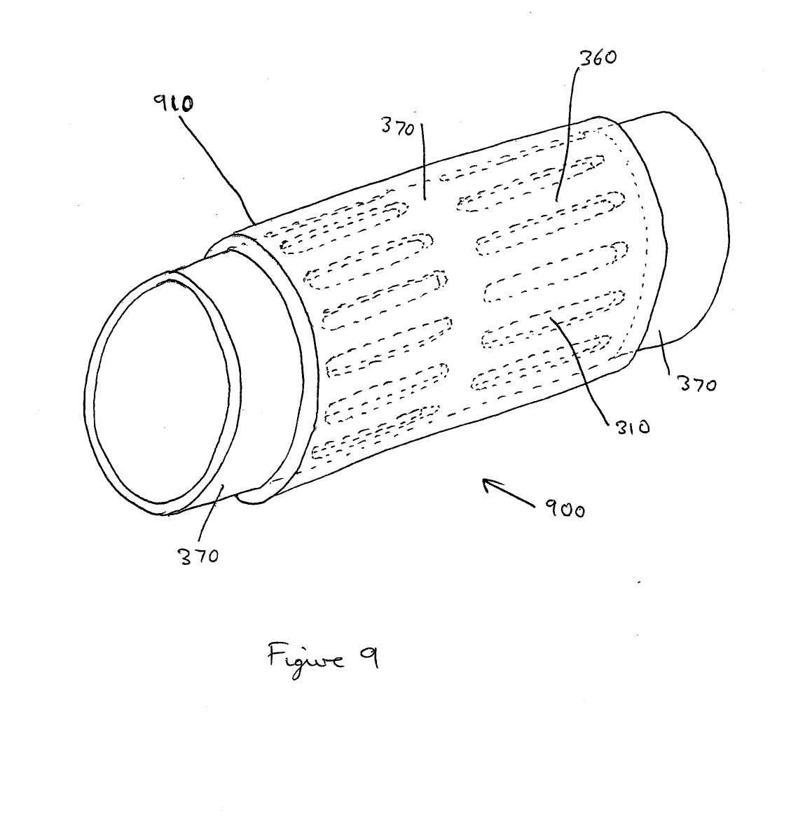

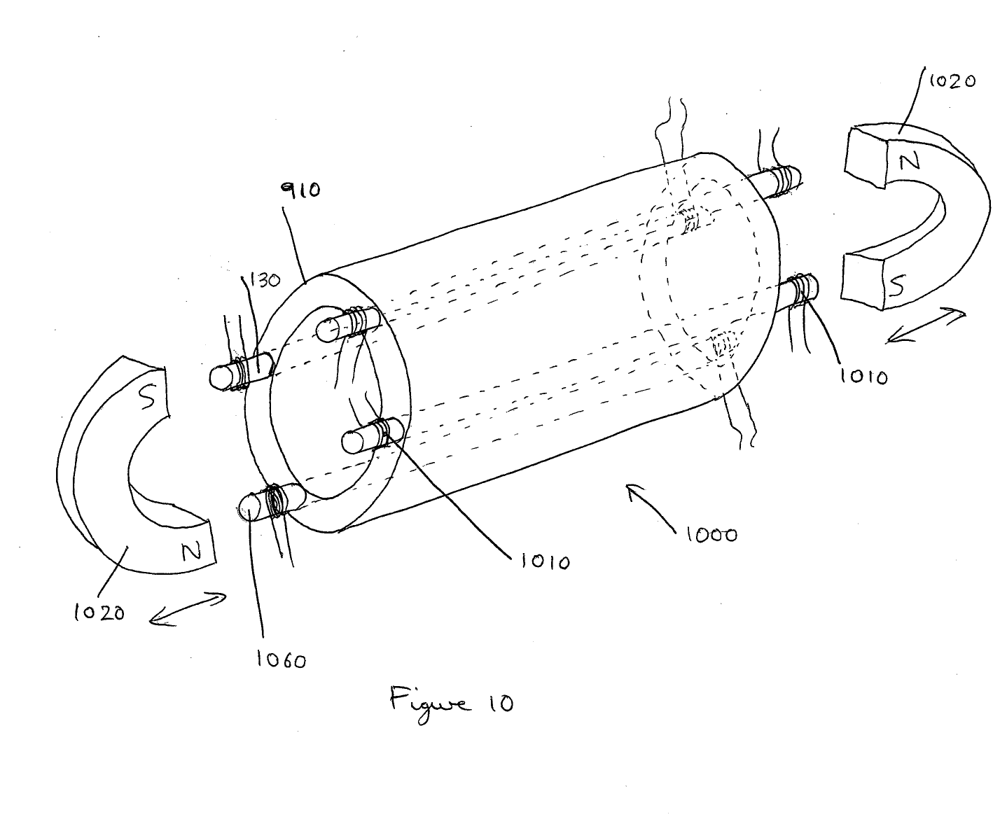

A further alternative embodiment is shown in FIG. 7 which shows a net 700 (similar to the net 300 shown in FIG. 3) which is arranged such that it can be rolled up to produce a magnetic pole cage 400, 500, 600 similar to that of the embodiment shown in FIG. 6, but with sloping coupling elements 760, rather than discrete staggered coupling elements 661 to 664, as shown in FIG. 6.

The sloping coupling elements 760 of FIG. 7 reduce variation in torque coupling capability (cogging), thereby enabling a reduction in size of the components of a magnetic gear employing such a design, and thereby a reduction in its cost. A sloping coupling element 760 will produce a resulting axial force. This axial force may be useful in some applications to bias the rotating parts against an axial end. Alternatively, the axial force can be cancelled by arranging the sloping coupling elements 760 in a symmetrical V or chevron pattern similar to the coupling element 234 in FIG. 2c. Other continuously varying shapes of coupling element can be used, for example sinusoids, curves, zigzags.

It will be appreciated that by providing the continuous or cage-like structure, a cogging-reducing configuration is provided with both structural strength and ease of manufacture.

In the magnetic gear shown in FIG. 2a, the coupling elements 230 may be only a couple of millimetres in diameter with suspended length in excess of 100 mm with no support. The preceding embodiments of the invention, specifically the pole cage 400 shown in FIG. 4, FIG. 5 and FIG. 6, which is conveniently constructed from the nets 300, 700 shown in FIGS. 3 and 7, help to mechanically support the coupling elements 360. This is achieved firstly by incorporating the circumferential support members 370 thereby providing hoop strength to the pole cage. Furthermore, the integral construction provides additional strength. Yet further these circumferential support members 370 serve to support and divide the coupling elements 360 into segments, thereby reducing the unsupported length of the coupling elements 360. A problem with existing unsupported coupling elements is that they are prone to being bent by forces in use. The circumferential support members 370 mitigate this such that the coupling elements 360 vibrate or resonate in use to a reduced extent. Simultaneous and sustained vibrations and/or resonance of the coupling elements is undesirable.

Resonance problems can be mitigated still further by the arrangement of FIG. 8 which shows an alternative embodiment of a net 800 arranged to be rolled into a pole cage, and having support members 370 at the ends of the net 800, so as to form circumferential support members 370 when the net 800 is rolled up to form a barrel shaped pole cage as in FIG. 4. In this embodiment, support elements 820 divide the holes 310 along the axial length (in the direction CD) and are irregularly spaced. Furthermore the support elements 820 do not all align with each other in adjacent rows. The resulting pole cage can have circumferential support members 370. Effective bracing and overall circumferential support results from the many interconnected supported elements 820 which prevent substantial flexing of the coupling element portions 861, 862, 863, 864, 865. Again the cage can be formed in any other appropriate manner.

It will be noted that the coupling element portions 861-865 resultingly are of differing unsupported lengths determined by the distance between any two adjacent support elements on the same or opposite sides of the coupling element portion. They therefore each have differing masses and stiffnesses and consequently, differing resonant frequencies. Therefore, in operation, it is made much more unlikely that a significant proportion of the coupling element portions 861-865 will resonate at the same or a similar frequency. Thus, at any given rotational speed of the magnetic gear, it is unlikely that resonance problems will be experienced. This has the advantage of improving the mechanical reliability of the assembly as well as reducing the required strength of the pole cage, (for rigidity), and allowing it to be made lighter, more compact and cheaper.

As discussed above any appropriate formation technique can be used. In some embodiments, the pole cage can be overmoulded, for example with plastic using an injection moulding process. The pole cage 400 provides a structure to which the moulded material can adhere. Further, the moulded material (which could be plastic, rubber, glass or any other material suitable for moulding) and the pole cage 400 provide mutual support to each other. Further, the moulded material provides a barrier to the passage of fluids through the holes 310 of the pole cage 400. This advantageously provides a convenient way of constructing a vacuum barrier between the first and second members 110, 120.

If the second member 110 forms a high-speed flywheel, such an arrangement allows the flywheel to operate in a vacuum while being magnetically coupled through the fluidically sealed pole cage 400 to the first member 120. This allows the vacuum chamber to be sealed without the use of rotating seals, as described above. Running a flywheel in a vacuum is useful since it avoids air resistance (“windage”) related losses. This becomes even more important if the flywheel runs at supersonic speeds. The vacuum avoids supersonic shockwaves and/or overheating due to friction with air. This arrangement is advantageous compared with some existing arrangements where the vacuum chamber wall thickness forms part of the “air gap” between the coupling elements, since in those existing arrangements the ease with which magnetic flux is able to pass from one coupling element to the other is reduced, therefore the flux density is reduced, and the torque coupling capability is resultingly reduced. The present invention, in embodiments, provides coupling elements moulded into the vacuum wall thereby reducing this total “air gap”.

When the magnetic gear coupling of FIG. 1a is incorporated in a vacuum enclosed flywheel application, the coupling elements 130 are incorporated in the vacuum chamber 140 wall. This has the advantage that the vacuum chamber wall thickness does not contribute to the total “air gap” between the poles of the first and second members 110, 120. The total “air gap” is made up of the gap between the surface of the first member poles 115, 116 and the surface of the vacuum chamber 140 wall, plus the vacuum chamber wall 140 thickness, plus the gap between the vacuum chamber 140 wall and the second member poles 125, 126, minus the thickness of the coupling element. Thus, the coupling element significantly reduces the total air gap. A smaller air gap has less reluctance, thereby allowing a greater flux density between the poles of the first and second members in use, since Flux Density (B)=field intensity (H)/(Reluctance (R)*Area(A)). As the torque is directly related to the rate of change of field energy the greater the Flux Density the greater torque coupling capability (or torque density), for example per gram of magnetic material. This is highly advantageous over conventional arrangements using magnetic couplings through a vacuum chamber wall. The first member 120 may, by virtue of the gearing effect of the magnetic gear so formed, be operated at a lower speed than the high speed flywheel. The high speed flywheel (second member 110) does not suffer from windage losses since it operates in a vacuum, meanwhile windage losses of the first member 120 are reduced by virtue of its reduced operating speed.

Furthermore, the material forming the vacuum barrier 910, which is overmoulded around the pole cage 400, can be rubber or a similar compound having frictional damping properties. The use of such a material having frictional damping properties would further serve to reduce potential vibration and resonance problems with the coupling elements 360 of the pole cage 400.

Of course, it would be possible to construct a pole cage 400 from variations on the net shown in FIG. 3. For example, one or both of the ends 340, 350 could be omitted and the join made instead at the ends of the support members 370. Also, one or both of the support members 370 at the axial ends of the pole cage 400 could be omitted.

Greater or lesser reliance for mechanical support could be placed on the overmoulded material. It is possible that a pole cage could be constructed having only the end support members 370 and no central support member. In manufacture, once the overmoulded material has cured, the end support members 370 could be removed, leaving coupling elements 360 supported only by the overmoulded material and not by any support member 370. Furthermore, the pole cage could be constructed from laminated sheet so as to reduce losses from eddy currents. Also, the sheet of material from which the net 300 is formed could be formed of a stack of thin portions in the direction AB such that when formed into a barrel shaped pole cage 400 as in FIG. 4, the pole cage is comprised of radial laminations, so as to further reduce losses from eddy currents.

The material used to overmould the pole cage 400, in addition to being suitable for injection moulding or another moulding process, must also have a significantly lower magnetic permeability (for example, by a factor of about 1000) than the material (for example steel) used for the pole cage 400 itself, and must have a much lower electrical conductivity than the material used for the pole cage 400 (for example, by a factor of about 1000 to 100000). Of course, greater or lesser differences than the examples given above will also yield the advantages of the invention to a greater or lesser amount.

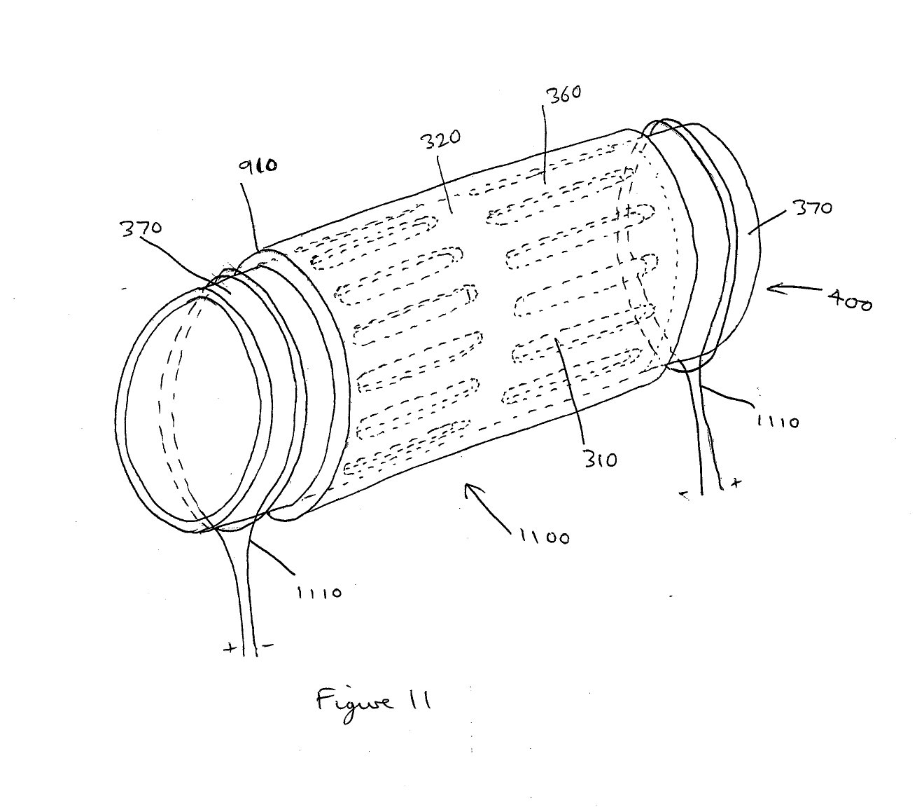

In a further embodiment of the invention an apparatus and method are provided for selectively decoupling drive between the first and second members 110, 120 of a magnetic gear as shown in FIG. 1a, and in FIG. 2a. As shown in FIG. 10, coupling elements 130 are arranged in a barrel, the barrel arranged concentrically between the first and second members 110, 120 of the magnetic gear 100. Electrical coils 1010 are arranged around some or all of the coupling elements 130. This is conveniently done by arranging the coils around the ends of the coupling elements 130. The coils 1010 can be wired separately, in series, or in parallel or a larger coil could take the place of two or more coils.

In operation, when no current is passing through the coils 1010, the magnetic gear incorporating coupling elements 130 as shown in FIG. 10 operates normally, with lines of flux passing from the magnetic poles of the first member 110 through the coupling elements 130 and to the magnetic poles 125, 126 of the second member 120 and vice versa. The first and second members 110, 120 concentrically counter-rotate and the lines of flux 170 (as shown in FIGS. 1c to 1e) move as the members rotate, thereby transmitting torque. Movement of one member thereby causes movement of the other member. In this state, the two members are said to be coupled together. This is by virtue of the lines of flux passing between the magnetic poles of each member.

When the coils 1010 are energised by passing electrical current therethrough, magnetic flux is induced in the coupling elements 130. If sufficient current is passed through the coils 1010, then sufficient magnetic flux can be induced in the coupling elements 130 so as to cause the material from which they are made to reach the point of magnetic saturation. At saturation, the coupling element material is unable to accept further magnetic flux. Since flux is a scalar, not a vector, it is unimportant in which direction the magnetic flux is attempting to travel through the material in. Therefore, when coils 1010 are energised and the coupling elements 130 are saturated, the coupling elements 130 will not accept the passage of flux 170 through the coupling elements 130. Instead, the lines of flux tend to pass directly from one magnetic pole 115 to the opposite magnetic pole 116 adjacent on the same member 110, and the lines of flux do not pass from the poles 125, 126 of the first member 120 to the poles 115, 116 of the second member 110. Thus, when the first member 120 rotates, the lines of flux do not change path relative to the poles. No torque is transmitted to the second member 110 therefore. In this state, the magnetic gear is said to be decoupled.

Although the coupling elements 130 are unable to accept passage of magnetic flux therethrough when in the saturated state, magnetic flux is able to pass through the gaps between the coupling elements 130. However, because the “air gap” between the poles of the first and second members 110, 120 is relatively large, very little magnetic flux passes through the gap. The magnetic gear is therefore effectively decoupled when the coupling elements are in the saturated state. Furthermore, the saturated coupling elements 130 actively reject passage of flux therethrough.

FIG. 14 is a graph of magnetic flux strength versus “air gap” (the gap need not consist of air, but can be any material with low magnetic permeability). The figure shows that the empirically determined ideal air gap is around 1 mm in the embodiments which have been tested, and flux strength rapidly falls off thereafter with increasing air gap. In the tested embodiments, where the coupling elements are of approximately 2 mm diameter and a 1 mm air gap exists either side between first and second members 110, 120, the coupling element 130 is ideally spaced to couple magnetic flux from the first member 120 to the coupling element and to the second member 110 and vice versa. Magnetic flux is therefore able to pass between the poles 115, 116, 125, 126 of the first and second members 110, 120 via the coupling element 130. When in the saturated state, the effective air gap increases to about 4 mm where it can be seen from the figure that magnetic flux is substantially reduced.

Furthermore, the spacing of the coupling elements 130 is chosen, as previously mentioned, as a function of the number of pole pairs of the first and second members 11, 120. This is to optimise the spatial arrangement of the lines of flux when in use, thereby allowing transmission of the maximum possible torque between the members. When the coupling elements 130 are saturated, they effectively “disappear”, in that they no longer spatially direct the lines of flux through defined points in space. The lines of flux thereby fail to couple flux between the poles of the first and second members 110, 120 in a regular, ordered manner, thus further reducing coupling effectiveness when the coupling elements 130 are saturated.

An alternative to having electrical coils for generating magnetic flux for saturating the coupling elements 130 is to use movable permanent magnets 1020, such as rare earth magnets. Preferably, the magnets should be powerful enough to substantially saturate the material of the coupling element 130. The magnets can be slid or rotated or otherwise moved in an out of position so as to complete a magnetic circuit through the coupling elements so as to cause magnetic flux to pass therethrough and thereby saturate the coupling elements 130.

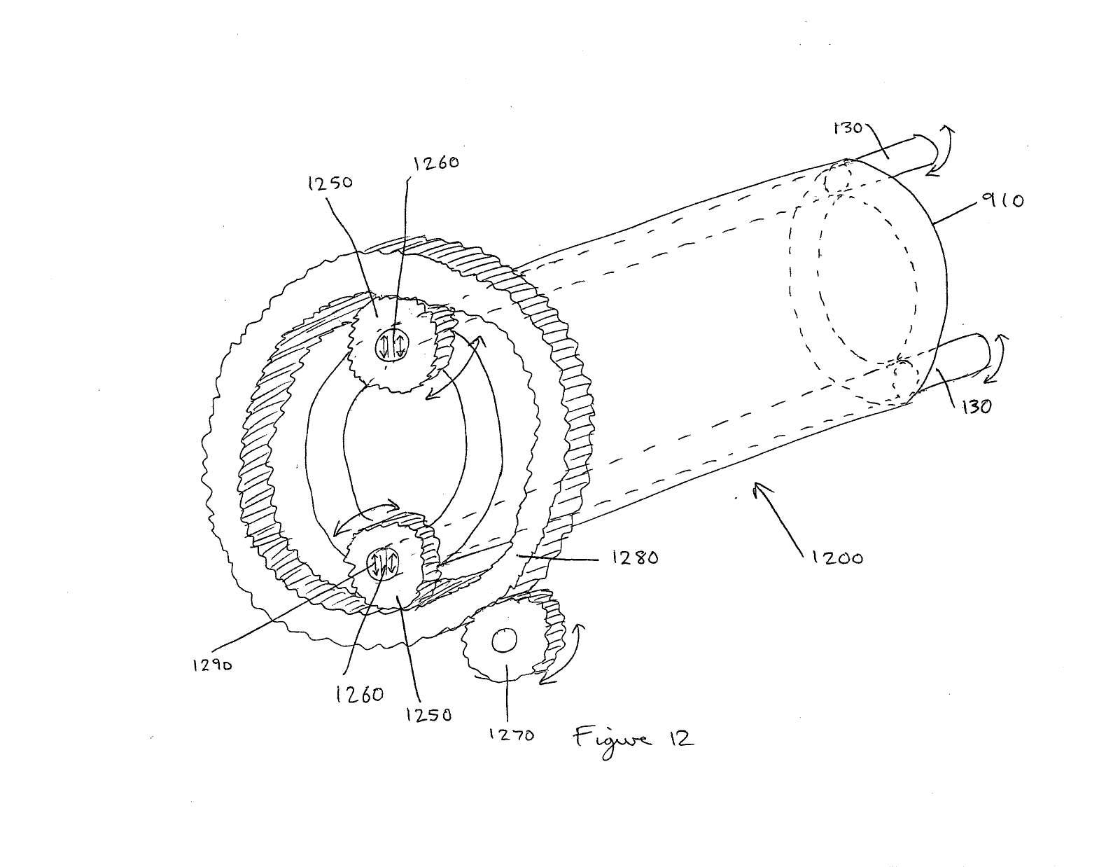

Although FIG. 10 shows discrete coils 1010 arranged around both ends of discrete coupling elements 130, as shown in FIG. 11, another arrangement is where a pair of larger coils 1110 is placed around each end of the pole cage 400 shown in FIG. 4. The coupling elements 360 of the pole cage 400 would be saturated in use when current was passed through the coils 1110. The support elements 370 at each end of the barrel of the pole cage 400 can be made sufficiently wide so as to accommodate the coils 1110. The coils 1110 can be made of copper wire or other conductors having low resistance, such as aluminium or a high temperature super conducting material.

Cooling coils of tubing for carrying cooling fluid (not shown) can also be optionally arranged around the pole cage, and optionally through the overmoulded material 910 so as to maintain the pole cage at a desired temperature, which, if using super conducting conductors for the cooling coils, would carry suitable cooling fluid such as liquid nitrogen.

Other methods of saturating the magnetic material of the coupling elements 130, 360 can be employed. Such methods can include applying stress to the coupling element material, either by tension, compression or torsion. Alternatively, the temperature of the coupling element material can be varied to vary its saturation point. The mechanical methods described above affect the properties of the material of which the coupling elements (130) are made, thus lowering the saturation point of the material and causing saturation, thereby having the same effect as applying additional flux to the coupling element 130, by (for example) exciting a coil as previously described.

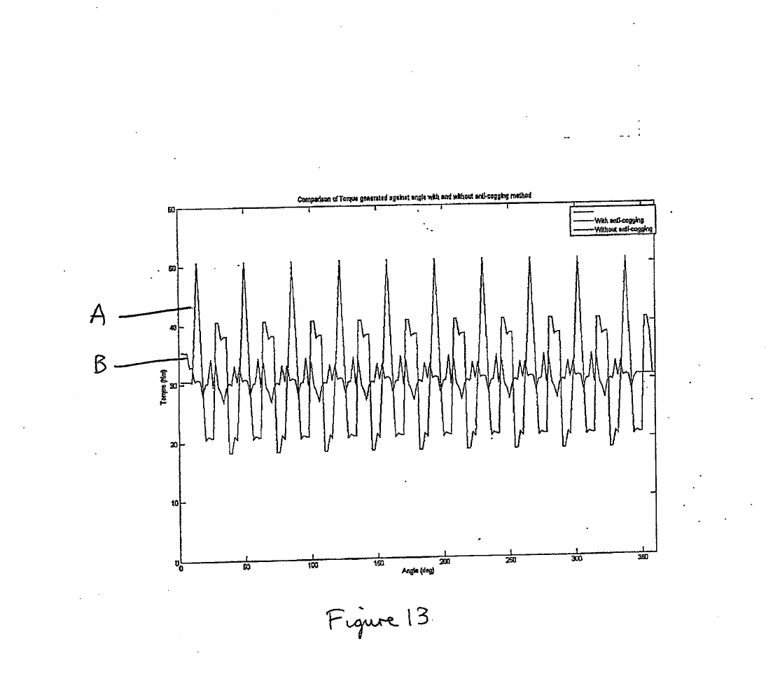

In another embodiment, as shown in FIG. 12, the coupling elements 1260 are made of a material having a directional grain structure 1290. Thereby, when the coupling elements 130 are rotated, the saturation point of the material of the coupling elements 130 changes, thereby allowing the coupling elements 130 to be saturated and the level of magnetic flux coupling between the first and second members 110, 120 to be varied. Rotation can be achieved, for example using a common outer gear 1280 driven by an external gear 1270 to rotate inner gears 1250 rotating the coupling elements 1260.

This controllable clutch arrangement hence allows control of slippage. In operation, slippage is defined as the condition when the torque coupling capability of the magnetic gear is overcome by an externally applied torque between the first and second members 110, 120. In such a situation, the opposing force generated by the lines of flux passing between the magnetic poles of the first and second members 110, 120 (via the coupling elements 130) is overcome. When such a condition occurs, one of the first and second members 110, 120 is caused to move out of synchronisation with the other member, thereby “slipping” past it. When such slippage occurs, lines of flux are broken and remade in a different position. In a slippage condition, the power dissipated in the magnetic gear is related to the slippage rate and to the strength of the magnetic flux passing between the poles of the first member 120 and the poles of the second member 110.

In use, the decoupleable magnetic gear of this second embodiment is normally in one of two conditions: the low slip and coupled condition, and the high slip and decoupled condition.

In the low slip and coupled condition, the magnetic flux between the poles of the first and second members 110, 120 is relatively high and the slippage rate is low or zero, with the first and second members 110, 120 counter rotating in synchronisation, according to the gear ratio produced by the relative number of magnetic pole pairs in each of the first and second members, 110, 120. Since the slippage rate is low or zero, the power dissipated in the magnetic gear is also low.

In the high slip and decoupled condition, the magnetic flux between the poles of the first and second members 110, 120 is low (because the coupling elements 130 are saturated are therefore will not accept further flux flow through them). In this decoupled state, since there is little or no magnetic flux interaction between the poles of the first and second members 110, 120, there is little or no torque transferred between the first and second members, therefore the first and second members 110, 120 are free to rotate at different speeds. The slippage rate is potentially very high, however, because the magnetic flux flowing through the coupling element is very low or zero there is again very little power dissipated in the magnetic gear.

When the decoupleable magnetic gear is changed from the decoupled to the coupled state, the first and second members may be rotating at very different relative speeds and directions compared to their normal directions and speed ratio for the coupled, low slip state (as determined by the number of magnetic poles in each). Thus, when the magnetic gear is changed to the coupled state by de-energising the coils 1010 or moving the permanent magnets 1020 away from the coupling elements 360, for an initial period, the slip rate and the magnetic flux between the poles of the first and second members 110, 120 may simultaneously be high, leading to a relatively large power dissipation in the magnetic gear. The present invention further allows reduced energy loss during the transition.

In particular the first and second members 110, 120 can be re-coupled only when slippage is low. To accomplish this, in some embodiments a speed sensor is employed on the first and second members 110, 120 so as to allow determination of when the relative speeds of the members are optimal for the magnetic gear to be changed into the coupled state. Control of the appropriate instant in time to re-couple the gear can be achieved under control of a digital computer having as its inputs the data from the two speed sensors as previously mentioned and having under control of one of its outputs the electrical coils 1010 or an actuator for controlling movement of permanent magnets 1020. In this way efficiency can be increased by reducing wasteful conversion of energy into heat. Furthermore, possible damage by overheating of the components of the magnetic gear can thereby be avoided.

It can be further seen that such a decoupleable magnetic gear according to this second embodiment is advantageous in that it is simple and has no moving parts, nor any clutch surfaces which would be subject to wear caused by contact. It is relatively robust, reliable and cheap. Furthermore, by employing the embodiments shown in FIG. 11 which has the decoupleable feature by virtue of the coils 1110 and also has the vacuum membrane 910 overmoulded onto the pole cage 400, a flywheel storage system can be extremely simply and conveniently constructed, whereby the flywheel operates in a vacuum and is coupled via a gear ratio to a driveshaft and the flywheel is furthermore decoupleable by simple and reliable means, the decoupling means also being very conveniently arranged for control by a digital computer without the need for mechanical actuators. Furthermore, in operation in the decoupled state, due to the low magnetic flux passing from the poles of the first member 1010 to those of the second member 120 (by virtue of the inhibiting effect of the saturated coupling elements 360), low drag can be achieved when in the decoupled state. This low drag results in a reduction in loss of energy from the flywheel when the flywheel is rotating at high speed relative to the driveshaft and the decoupleable magnetic gear is in the decoupled state. This improves efficiency and allows for longer term energy storage in the flywheel.

It will be noted that a decoupleable magnetic gear as set out with reference to FIGS. 10 to 12 above is not limited to use with flywheels. It can be used in any situation where a clutch is required, such as in a wind turbine. Such a decoupleable magnetic gear can also be used in the final drive of a vehicle and allows implementation of the final drive ratio, while also replacing or augmenting the conventional clutch normally placed between engine and gearbox. For example, when a vehicle is in the freewheeling condition, a magnetic gear clutch situated in the final drive could be used to disengage the gearbox from the driven wheels, thereby reducing friction. Another application would be in four wheel drive transmissions whereby such a decoupleable magnetic gear could provide a final drive with a gear ratio when required, and also selectably enable decoupling of two of the driven wheels when not required in order to reduce friction.

Furthermore, the use of a permanent magnet or a coil to saturate a magnetic coupling element need not be limited to use with a magnetic gear. Other embodiments and variations will be apparent to a skilled person and are considered to be within the scope of the invention which is defined in the claims. Furthermore, features of any of the described embodiments can be combined with features of any of the other described embodiments.

A magnetic gear coupling according to any of the described embodiments also has the advantage the if an over-torque condition occurs, the coupling relatively harmlessly slips while the over-torque condition exists, and then later resumes normal function with potentially no adverse effects. Furthermore, due to Enshaw's Law, only torsional energy is transferred via the magnetic gear coupling, therefore the coupling gives axial and radial isolation in respect of vibration. In an alternative arrangement, the coupling elements 130 could be supported in a third member which is driven by a shaft or could drive a shaft, so as to provide further gearing ratios.

Furthermore, the “anti-cogging” features incorporated in certain embodiments, as previously described, allow the use of smaller permanent magnets (due to the minimum torque coupling capability being closer to the mean torque coupling capability) with associated advantages of lower cost and weight, thereby increasing the energy storage density of the flywheel. Smaller magnets also enable a higher gearing ratio to be produced since a greater number of north/south pole pairs can be packed into a flywheel of a given size. This higher gearing ratio further reduces losses associated with air resistance or windage, on the air side of the device, further increasing efficiency of the flywheel and its energy storage density. A further advantage of the anti-cogging features previously described is an improvement in noise vibration and harshness, and extended service life of components due to the reduction in torsional vibration brought about by these features. This will also allow components to be re-specified so as to use cheaper material, or less material, thereby bringing about cost and/or weight advantages. Manufacturing efficiencies may also be gained from the ability to use materials which would not have withstood torsional vibrations, but which are easier to machine or process during manufacturing.

It will be seen that as a result of the features described above, a stronger safer, lighter, more efficient and more effective flywheel can be provided for energy storage.

Of course it will be appreciated that features of the described embodiments can combined in any combination and can be used in applications other than flywheel applications, for example any magnetic gearing or coupling application.

1. A magnetic flux coupling element for coupling magnetic flux between first and second members each having an array of magnetic field generating elements, at least one of the members and the coupling element having a direction of relative movement therebetween, wherein:
the magnetic flux coupling element comprises one or more magnetic flux coupling portions extending in a direction perpendicular to the direction of relative movement, integrally formed with and supported by one or more support portions.

2. The magnetic flux coupling element as claimed in claim 1 in which the element is generally cylindrical and the direction of relative movement is in the circumferential direction.

3. The magnetic flux coupling element as claimed in claim 1 in which the magnetic flux coupling element comprises a web formed of the magnetic flux coupling portions and support portions defining spaces therebetween.

4. The magnetic flux coupling element as claimed in claim 1, wherein the magnetic flux coupling element is formed from magnetically permeable material.

5. The magnetic flux coupling element as claimed in claim 1 in which magnetic flux coupling portions are at least partially separated by spaces having substantially lower magnetic permeability, and preferably in which the spaces have a magnetic permeability which is a factor of at least about 100 times less than that of the coupling portions.

6. The magnetic flux coupling element as claimed in claim 1 in which a magnetic flux coupling portion is attached to or embedded in a support.

7. The magnetic flux coupling element as claimed in claim 6 in which the support is arranged to prevent the passage of fluid between the coupling elements.

8. The magnetic flux coupling element as claimed in claim 1 in which a magnetic flux coupling portion extends substantially perpendicular to the direction of relative movement along a part of the length of the element, and is staggered circumferentially relative to another said portion.

9. The magnetic flux coupling element as claimed in claim 1 in which a magnetic flux coupling portion extends at a non-perpendicular angle to the direction of relative movement along at least a part of the length of the element, and wherein the angle between the magnetic flux coupling portion and the direction of relative movement is less than 90 degrees and greater than about 30 degrees.

10. The magnetic flux coupling element as claimed in claim 1 in which a support portion extends substantially parallel to the direction of relative movement.

11. The magnetic flux coupling element as claimed in claim 10 in which the element is generally cylindrical and a support portion extends in a circumferential direction.

12. The magnetic flux coupling element as claimed in claim 11 in which the support portion extends around the entire element.

13. The magnetic flux coupling element as claimed in claim 11 in which the support portion extends partially around the element.

14. The magnetic flux coupling element as claimed in claim 1 in which the magnetic flux coupling portions extend perpendicular to the support portion defining spaces therebetween, elongate in the direction in which the magnetic flux coupling portions extend.

15. A magnetic machine comprising a magnetic flux coupling element as claimed in claim 1 provided between first and second members each having an array of magnetic field generating elements.

16. The magnetic machine as claimed in claim 15 in which the magnetic field generating elements of the first and second members are arranged to generate a magnetic field which alternates in the direction of relative movement.

17. The magnetic machine as claimed in claim 15 in which the first and second members are movable in opposing directions relative to the coupling element.

18. The magnetic machine according to claim 15 in which the field generating elements are permanent magnet poles.

19. The magnetic machine according to claim 15 in which the array of at least one of the members is an array of electromagnetic poles, the electromagnetic poles arranged to generate an alternating magnetic field pattern which is movable in the direction of relative movement.

20. The magnetic machine as claimed in claim 15 comprising a flywheel or gear assembly.

21. A magnetic flux coupling element for coupling magnetic flux between first and second members each having an array of magnetic field generating elements, and defining a direction of relative movement between at least one of the members and the coupling element, wherein:
the magnetic flux coupling element comprises one or more magnetic flux coupling portions each having first and second ends and extending in a direction perpendicular to the direction of relative movement, and supported by one or more support portions intermediate the first and second ends.

22. A method of manufacturing a magnetic flux coupling element for coupling magnetic flux between first and second members each having an array of magnetic field generating elements, and defining a direction of relative movement between at least one of the members and the coupling element, the method comprising forming from magnetically conducting material one or more magnetic flux coupling portions extending with a component perpendicular to the direction of relative movement and further integrally forming one or more support portions supporting the magnetic flux coupling element.

23. The method as claimed in claim 22 in which the magnetic flux coupling element is formed by rolling a sheet of magnetically permeable material comprising said magnetic flux coupling portions and support portions.

24. The method as claimed in claim 23 in which the sheet is shaped or stamped.

25. The method as claimed in claim 23 in which the sheet is arranged to comprise a support in which the coupling portions are embedded or to which the coupling portions are attached.

26. The method as claimed in claim 25 in which the support is moulded at least partially around the coupling portions.

27. The method as claimed in claim 25 in which the support is provided using a material which is substantially less magnetically permeable than the coupling portions.

28. The method as claimed in claim 25 in which the support is arranged to substantially fill spaces between the coupling portions so as to provide a seal against the passage of fluids therebetween.

29. A magnetic machine comprising a magnetic flux coupling element arranged for coupling magnetic flux between first and second members, the coupling element comprising a plurality of coupling portions spaced in a first direction, the first and second members each having an array of magnetic field generating elements spaced in the first direction, wherein the elements of one or both of the members are arranged for generating a magnetic field pattern which alternates and is movable along the member relative to the coupling element in the first direction.

30. A magnetic flux coupling apparatus for coupling flux between first and second magnetic poles, comprising a flux coupling element, and a saturation component arranged to substantially saturate the coupling element with magnetic flux in a saturation state.

31. The magnetic flux coupling apparatus as claimed in claim 30 in which the saturation component is arranged such that an auxiliary magnetic field can be selectively applied to substantially saturate the coupling element with magnetic flux.

32. The magnetic flux coupling apparatus as claimed in claim 31 in which the saturation component is arranged to use electricity to generate an auxiliary magnetic field.

33. The magnetic flux coupling apparatus as claimed in claim 32 in which the saturation component comprises a coil associated with a respective flux coupling element.

34. The magnetic flux coupling apparatus as claimed in claim 32 in which the saturation component comprises a coil associated with a plurality of flux coupling elements.

35. The magnetic flux coupling apparatus as claimed in claim 30 in which the flux coupling elements are made from material having a directional grain affecting its magnetic permeability and/or magnetic saturation properties, and the saturation component is arranged to rotate said flux coupling elements.

36. The magnetic flux coupling apparatus as claimed in claim 30 in which the saturation component is arranged to move permanent magnets out of proximity to the flux coupling element.

37. The magnetic flux coupling apparatus as claimed in claim 30 in which the saturation component is arranged to apply a stress force to the flux coupling elements.

38. The magnetic flux coupling apparatus as claimed in claim 30 in which the saturation component is arranged to alter temperature of the flux coupling elements.

39. The magnetic machine comprising a magnetic flux coupling apparatus as claimed in claim 30 provided between first and second movable members each having an array of magnetic poles.

40. The magnetic machine as claimed in claim 39 in which the first and second members each have an array of alternating magnetic poles, the poles alternating in the direction of relative movement.

41. The magnetic machine as claimed in claim 39 comprising a flywheel or gear assembly.

42. A method of controlling a magnetic flux coupling apparatus for coupling flux between first and second magnetic poles, having a flux coupling element, and a saturation component arranged to substantially saturate the coupling element with magnetic flux in a saturation state, the method comprising sensing from at least one sensor input a decoupling condition, and upon sensing the decoupling condition activating the saturation component.

43. The method as claimed in claim 42 in which the sensor input carries information relating to a relative speed and/or direction of movement of one or more of the first and second magnetic poles and flux coupling element, and in which the decoupling condition exists at a predetermined relative speed and/or direction of movement.

44. A computer readable medium storing a computer implementable instructions for implementing the method of claim 43.

45. A computer arranged to operate under the instructions stored on the computer readable medium of claim 44.

46. (canceled)
